(19) United States
(12) Patent Application Publication
(10) Pub. No.: US 2005/0050285 A1
(43) Pub. Date: Mar. 3, 2005

(54) Memory control system and method for installing new memory

(76) Inventors: William Robert Haas, Fort Collins, CO (US); Kirk Steven Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/649,906

(22) Filed: Aug. 26, 2003

(51) Int. Cl. G06F 12/16

(52) U.S. Cl. 711/162

(57) ABSTRACT

A system and method is described for installing a new memory into a redundant array of independent memories. The method comprises initiating a duplication function in a processor, transmitting an empty data indication from the new memory to the processor, and replicating application data from a first old memory to the new memory. An embodiment of the system comprises a processor, a bus in communication with the processor, a first memory in communication with the processor in a first data path removed from the bus, and a second memory in communication with the processor in a second data path removed from the bus and having an empty memory indicator so that, in response to the second memory containing no application data, it provides a corresponding indication to the processor.

### BACKGROUND

Portable electronic devices manufactured for capturing, creating, storing, manipulating or transferring digital music, sound, images, movies or other encoded data have become more prevalent with the advent of less expensive semiconductor processing and increased consumer demand. Consumer products such as portable MP3 (Moving Picture Experts Group Layer 3 Standard) players, digital cameras, PDAs (Electronic Personal Data Assistants) and digital voice recorders continue to gain popularity. The general trend for each of these commercial devices is to provide for greater data storage capability at reduced cost.

Unfortunately, greater memory in these devices is accompanied by an increase in cost and time wasted when such large amounts of data are lost. Many portable electronic devices have built-in memory with no redundancy so data cannot be recovered if a memory failure occurs. Even for devices that have the ability to provide back-up data, the time and sophistication required to restore previously backed-up data may be burdensome for the average consumer. Manufacturers are also faced with a more extensive design process, since the use of a PC (personal computer) to provide redundant data and backup also necessitates the design for and use of Microsoft Windows®, MAC®, or other operating system software to provide compatibility between the portable electronic devices and the PC. Also, should purchasers desire to upgrade memory devices in their products, a time consuming process ensues with the purchaser often using a PC to back up data for restoration onto the replacement memory.

Some manufacturers have attempted to solve these problems through increased data throughput to PC's for backup and file transfer. Unfortunately, often times, the single memories in these devices fail prior to back-up due to physical shock such as dropping or normal wear and tear.

Therefore, there exists a need for a system in portable electronic devices that provides for data redundancy without use of a PC, and that may provide for memory upgrade capability without the use of a PC in the transfer.

### SUMMARY

One embodiment of the present invention is described by a method of installing a new memory that has a processor and a first old memory, with the first old memory storing an amount of application data to produce a redundant array of independent memories. The method comprises initiating a duplication function in the processor, transmitting an empty data indication from the new memory to the processor, and replicating the application data from the first old memory to the new memory.

Also, a method is described for installing a new memory that has a predetermined capacity and a new memory ID into a system that comprises a processor and first and second memory IDs, first and second old memories, with the memories capable of storing application data. The method comprises removing the first of old memory from the system, installing the new memory into the system, determining whether the new memory ID matches either of the first or second memory IDs, and replicating the application data from the second old memory to the new memory if the new memory ID does not match either of the first or second memory IDs, to maintain a redundant array of independent memories.

An embodiment of the present invention comprises a processor, a bus in communication with the processor, a first memory in communication with the processor in a first data path removed from the bus, and a second memory in communication with the processor in a second data path removed from the bus and having an empty memory indicator so that, in response to the second memory containing no application data, the second memory provides a corresponding indication to the processor.

### BRIEF DESCRIPTION OF THE DRAWINGS

The components in the figures are not necessarily to scale, emphasis instead being placed upon illustrating the principals of exemplary embodiments of the invention. Moreover, in the figures, like reference numerals design corresponding parts throughout the different views.

FIG. 1 is a block diagram of a system of redundant memories in direct connection with a processor in accordance with one embodiment of the invention.

FIG. 2 is a flow diagram for replicating application data from an old memory to a new empty memory at the initiation of the user for the system shown in FIG. 1.

FIG. 3 is a flow diagram of a method for replicating application data from an old memory to a new memory at power-on for the system illustrated in FIG. 1.

FIG. 4 is an exploded perspective view illustrating a system of redundant memory to utilize the method of FIGS. 2 and 3.

FIGS. 5 and 6 are exploded perspective views illustrating three different systems of redundant memory utilized in a memory storage module at different locations in a portable electronic device.

### DETAILED DESCRIPTION

The invention provides a system for managing and storing data in memories for use with consumer applications such as MP3 players, digital recorders, or for use with any other electronic application allowing for the capture, creating, storing, manipulating or transferring of digital music, sounds, images, movies or other encoded data. Through the use of a plurality of memories, a redundant array of independent memories is available for a controller module and for one or a plurality of electronic applications. When one of the memories becomes damaged or available for upgrading, the user may remove the subject memory, reattach it in to the controller module and initiate a simple memory duplication function to replicate the old memory application data to the new memory without the use of a PC. One embodiment of the invention also provides for removal of a memory while the controller module is powered off, with the duplicator automatically initiating upon power-on to provide for duplication of the old memory application data to the new memory.

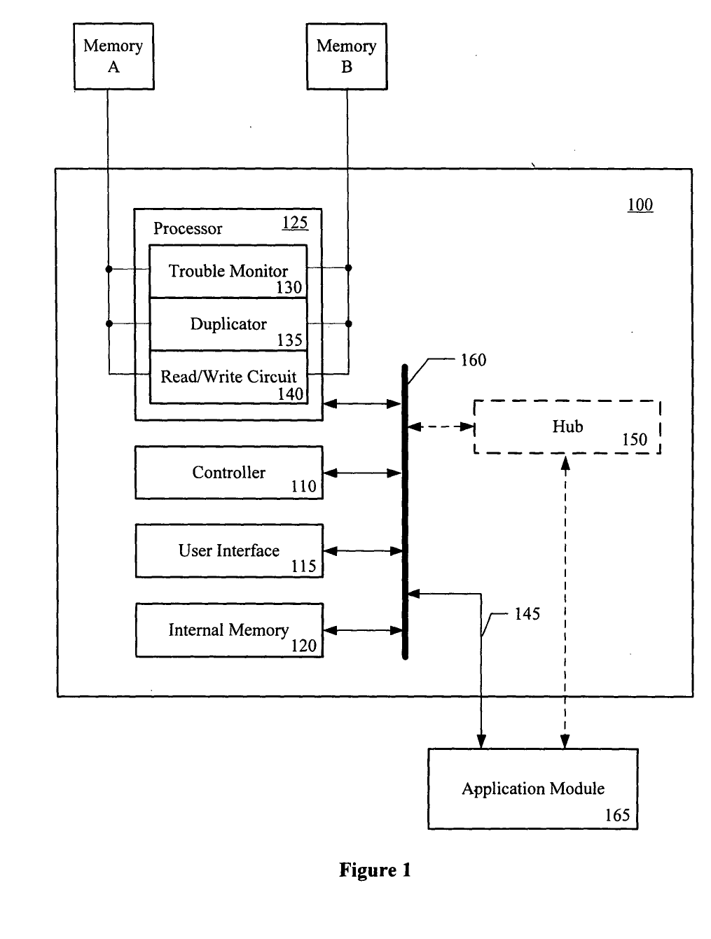

FIG. 1 illustrates an implementation scheme for a controller module 100. The controller module 100, sometimes referred to as a Compact Unlimited Library Controller (“CuL” Controller) is shown in communication with memories A and B and application module 165. The controller module 100 includes a bus 100 in communication with a controller 110, a user interface 115, an internal memory 120, and a processor 125. The various components manage the application data received through the data path 145 for the controller module 100 and manage data from and between Memories A and B. The processor 125 and controller 110 may be integrated into a single device. Similarly, internal memory 120 may be integrated onto a single chip with either the processor 125 or controller 110, or both.

The processor 125 provides several functions and comprises a trouble monitor 130, a duplicator 135 and a read/write circuit 140. The trouble monitor 130 and processor 125 detect whether memories connected to processor 125 are operating correctly, and notifies the user of problems through the user interface 115. The duplicator 135 enables direct duplication of application data between memory A to memory B when a memory is replaced, without the use of other external devices such as a PC. The duplicator 135 also communicates through the bus 160 with the user interface 115 to provide information to a user regarding duplication efforts. The read/write circuit 140 communicates with external applications such as the application module 165, and governs the read/write of data to master and slave memories memory A or memory B during normal operation. The elements 130, 135, 140 may be implemented in firmware or by using a software controlled general purpose DSP (digital signal processor). The bus 160 is illustrated with electrically conductive paths between the processor 125, controller 110, user interface 115, and internal memory 120. An optical bus may also be used, as well as any manner of signal conduit, medium, or signaling method. Details regarding the implementation of the above listed functions are well known in the art and have been omitted to avoid obscuring the described embodiment of the invention.

Memories A and B are shown in direct communication with processor 125. They could also communicate with the processor 125 through the bus 160 and utilize a data protocol having an addressing scheme managed by the processor 125 and controller 110.

In an alternative embodiment, a hub 150 may be provided in the controller module 100 to enable use of the controller module 100 with other applications. If the bus 160 communications with an application module 165 via the hub 150, the data path 145 may be deleted. A wireless scheme utilizing Bluetooth™ wireless technology or some similar wireless scheme could also be provided for a data path substitute between the controller module 100, memories A and B and an application module 165.

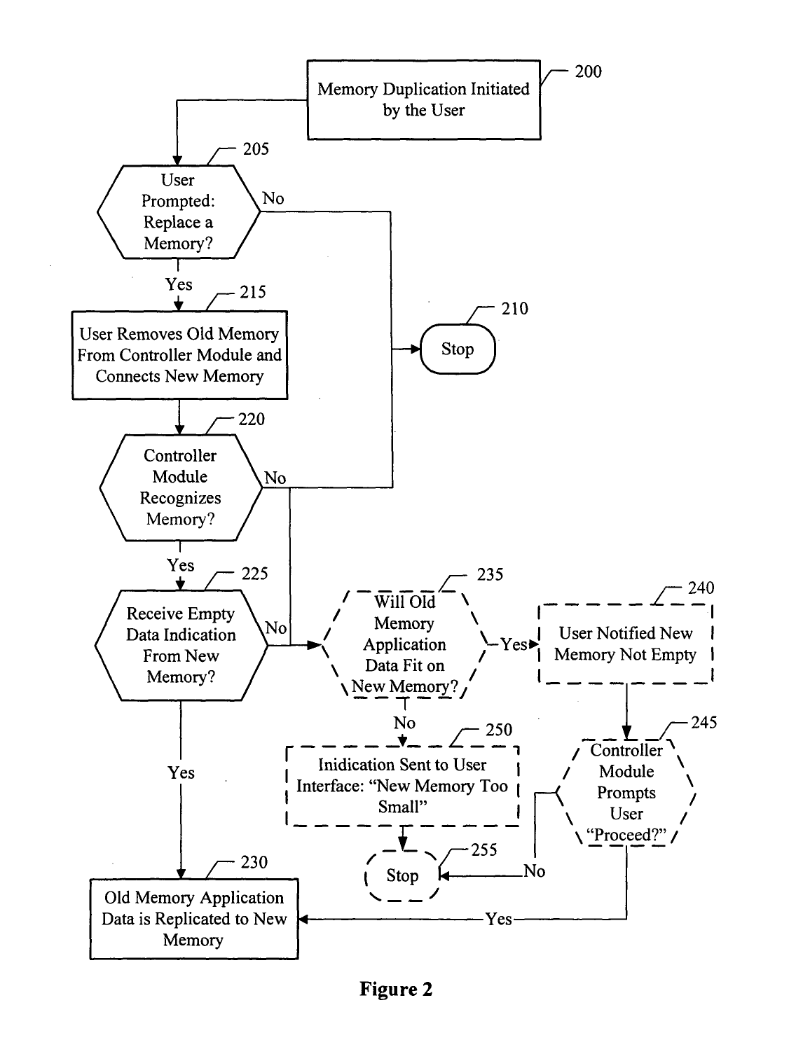

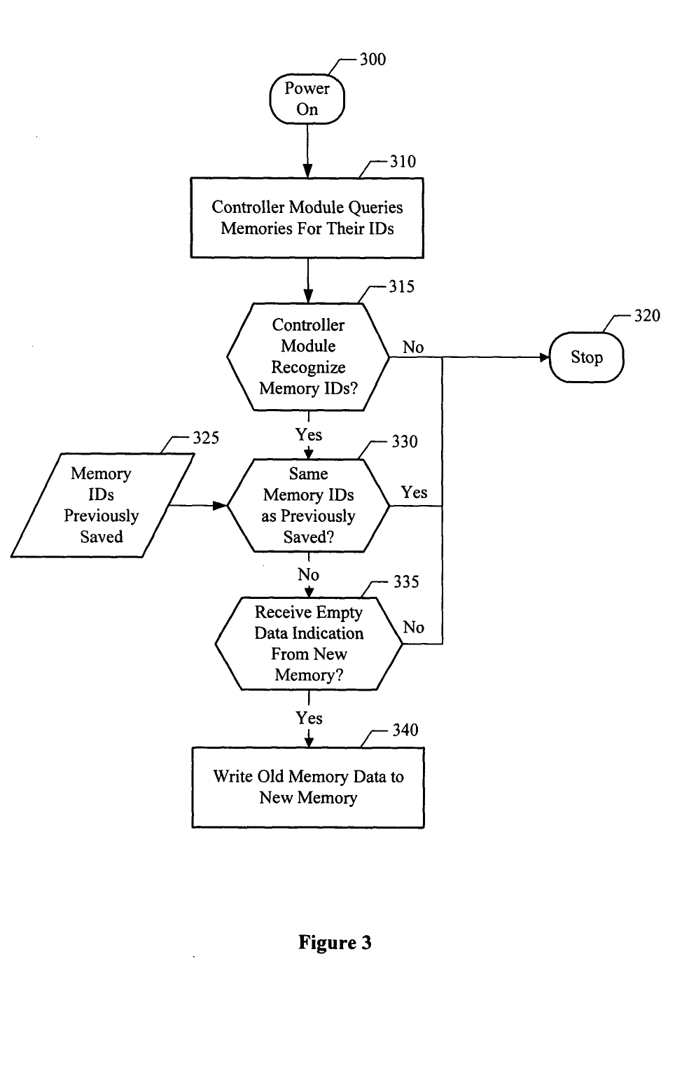

Referring to FIG. 2, an implementation scheme is illustrated for replicating data contained on an old memory connected the controller module 100. The duplicator action is initiated by the user through the user interface 115 on the controller module 100 (block 200). The user is then prompted through the user interface 115 to determine whether the user wants to replace either memory A or B (block 205). If the user selects “no” duplication action is stopped (block 210). If the user chooses to continue, he or she detaches the old memory from the controller module 100 and connects a new memory (block 215). The controller module attempts to recognize the newly attached memory (block 220). If the controller module 100 is unable to recognize the new memory, the duplication is stopped (block 210). If the new memory is recognized, the controller module looks for an empty data indication from the newly connected memory (block 225). If the empty data indication is not found, duplication is stopped (block 210). If the newly connected memory indicates through the empty data indication that the new memory is devoid of application data, the processor 125 replicates the data contained on the old memory to the newly connected memory to provide a replicated copy of the application data (block 230). Details of this operation are given in connection with FIG. 3, discussed below.

In an alternative implementation, indicated by dashed lines in FIG. 2, if the processor 125 receives no empty data indication from the new memory (block 225), the processor 125 may compare the data capacity of the new memory with the amount of application data to be replicated (block 235). If the processor 125 determines the old application data would fit on the new memory, the user may be notified that the newly connected memory device is not empty (block 240), and the controller module 100 may then prompt the user through the user interface 115 to determine whether or not the user wants to proceed with replicating the data (block 245). If the controller module 100 receives an affirmative response from the user, the old memory application data is replicated to the new memory (block 230). If, however, the old memory application data is found by the processor 125 to be too large for the capacity of the newly connected memory (block 235), an indication is sent to the user through the user interface 115 that the newly connected memory is too small (block 250) and the duplication is terminated (block 255).

Although various user prompts may be initiated by the controller module 100 through the user interface 115, such prompts may be omitted or may take the form of visual, oral, or some other indication appropriate to provide a check and balance in the process flow between inserting a new memory device to replicating the data.

The empty data indication provided to the processor 125 may also be an indication from an empty data flag on the new memory (block 225), or alternatively some other indication that the newly inserted memory does or does not contain user application data. For example, a physical indication may be provided with a mechanical tab on the newly inserted memory device. By way of further example, the newly inserted memory may actually be examined for existing data by the processor 125.

Referring to FIG. 3, an implementation scheme is illustrated for replicating data from an old memory to a newly connected memory connected to the controller module 100. The controller module 100 is powered on (block 300) and it queries the memories for their IDs (block 310). If the processor 125 determines that either memory A or B is not of a recognized standard or de facto standard for the device and hence unrecognizable (block 315), the process is stopped (block 320). If the memories are recognizable, then the memory IDs are compared against the memory IDs that were previously saved in internal memory 120. For example, the memory IDs may be saved at shut-down of the controller module 100. If the processor 125 determines that both memories are the same as those that existed prior to the previous save, the process is stopped (block 320). If a new memory is found, the processor 125 queries the new memory for an empty data indication (block 335), and the data from the old memory is mirrored to the new memory (block 340).

In an implementation, the IDs may be serial numbers unique to each memory. Also, the order in which the processor 125 queries the memories may be different. For example, the processor 125 may query memory A and B for an empty data indication prior to or in place of querying the memories for their IDs. Rather than saving memory IDs at shut down, the processor 125 may simply look for an empty data flag indication from each memory. Or, the processor 125 may look for any indication that the Memory A or Memory B is new or contains no data.

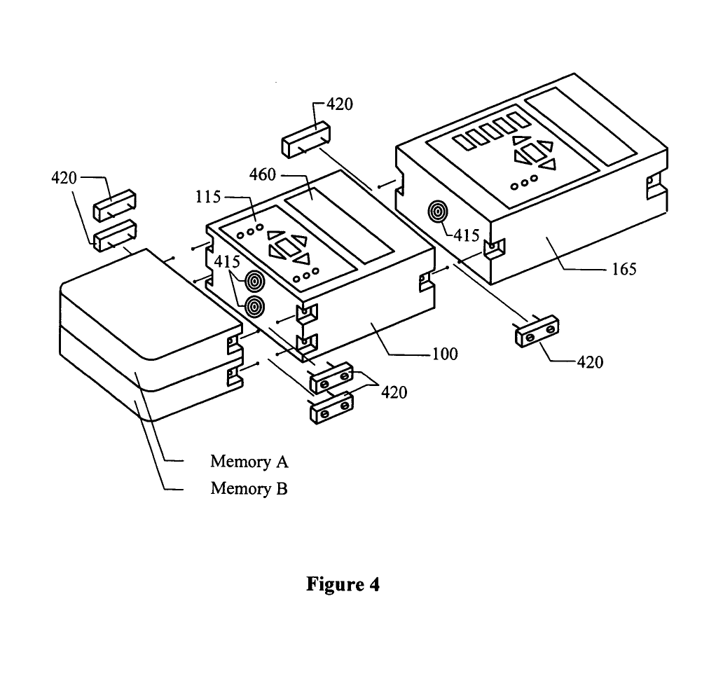

While the invention is applicable to multiple memory systems in general, embodiments of the invention are particularly useful for portable handheld modular consumer electronic products such as those shown in FIGS. 4, 5 and 6. Such a modular system allows a controller and multiple memories to be packaged together by the consumer with whichever application modules the consumer desires. In FIG. 4, a controller module 100 is shown aligned for electrical and mechanical connection with an application module 165 through an electrical connector 415 in the application module 165 and a complementary, opposed connector (not shown) in the controller module 100, and mechanical connectors 420. The controller module 100 manages application data sent from the application module 165 to the memories A and B.

The application module 165 may be any portable electronic consumer application such as a video/still image player or reviewer, a PDA, a digital still or video camera, or an MP3 player. The application module 165 can also be connected in turn to a second application module (not shown) through electrical and mechanical connectors similar to electrical connector 415 and mechanical connectors 420. In such a case, the controller module 100 may distinguish between the different application modules by a data addressing scheme.

The symmetrical electrical connector 415 allows the application module 165 to be connected to the system in numerous different orientations making assembly of the system easier for an untrained consumer. The module can be detached from the system and replaced with a different application, or additional application modules can be connected to the first one, again without regard to their exact orientation. Mechanical connectors 420 hold the modules together once they have been positioned. The electrical connector 415 is symmetric about an axis running through the application module 165 and controller module 100 to allow for different rotational orientations between modules without loss of electrical contact after the mechanical connectors 420 are engaged or re-engaged. The illustrated electrical connector 415 has four circular electrical contacts, providing two data paths and two power paths between the devices (100, 105). The connectors for adjacent modules are unisex in nature and spring-biased to extend slightly outward from their respective modules, providing a secure electrical contact when brought in contact with each other and held in place with mechanical connectors 420.

Alternatively, the electrical connectors 415 are not symmetric about their axes, but may allow for reorientation while maintaining suitable electrical connection after the mechanical connectors 420 are reengaged. The electrical connectors 415 may be provided with male and female clamps or the like so that they function as mechanical as well as electrical connectors, thus eliminating the need for separate mechanical connectors 420. The electrical connectors may have more or fewer than the four contacts illustrated, depending upon the data and power requirements of the intended modules.

Memories A and B are shown aligned for electrical connection with the controller module 100 through a pair of electrical connectors 415 in the controller module, and a complementary pair of electrical connectors (not shown) in the memories, one for each memory. Each memory can be individually replaced if it goes bad, and a new memory installed with either the same or a 180° rotated orientation with respect to the controller moduel 100. The electrical connectors 415 between the controller and memory modules have the same design as corresponding to the connector lines between the processor 125 and memories A and B, the electrical connectors 415 between the controller and application modules, which correspond to connector line 130 in FIG. 1.

The physical shapes of memories A and B, the controller module 100 and the application module 165 are illustrated as rectangular for convenience, but other shapes may be used as desired. The modules can be assembled in various geometric configurations. For example, and not by way of limitation, they may be stacked end-to-end along a linear axis, in an L or T shape, or in a square-like or some other commercially desirable shape. In such cases, the electrical connectors 415 and mechanical connectors 420, between the modules may need to be moved to other locations on their respective modules.

Controller module 100 is shown having a keypad user interface 120, and a display 460. The user interface 120 may alternately be a microphone for speech recognition, a pressure sensitive touch screen using thin film transistors (TFT), or some other device or combination of devices for inputting information (not shown). The display 460 provides information to the user regarding application data transfer, memory device activities, and data retrieval. Alternatively, the display 460 may be incorporated into the user interface 120 such as by utilizing a TFT screen, allowing for both display and receipt of information.

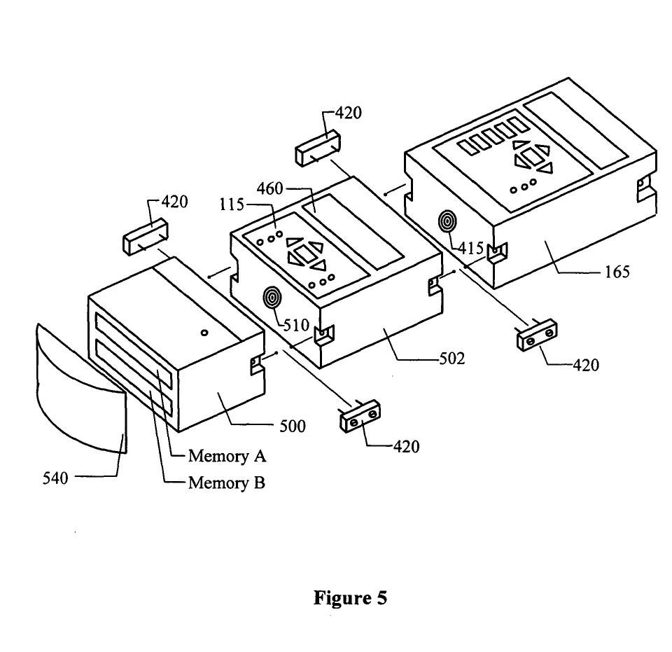

The embodiments shown in FIGS. 1-3 may also be implemented as shown in FIG. 5, in which memories A and B are seated in a common memory storage module 500 that is designed to receive standardized form factor memories. In this example, memories A and B are each microdisk drives inserted into the memory module 500. Examples of microdisk drives include the 340MB™ and 170MB™ products sold by IBM® Corporation. Other currently available small form factor memories that may be used in memory module 500 include a SmartMedia Card, Memory Stick, Multimedia Card or Miniature Card. Although memories A and B are inserted in one end of the memory module 500, they may be placed in different locations in the module. For example, the memory slots may be moved to the top or bottom, rather than the end, of the module. A cover 540 is shown covering the slots for memories A and B to protect them from damage. The cover is held in place by hinges, screws, a snap tab or other convenient mechanical arrangement, and may be provided as separate disengageable covers for each of the memories. Only a single electrical connector 510 is provided on the memory module 500 for mating with a similar single connector 510 on the opposed face of the controller module 502. In this embodiment both memories A and B are connected to a common electrical connector 510, with the controller module 502 distinguishing between them by assigning them different digital identification codes.

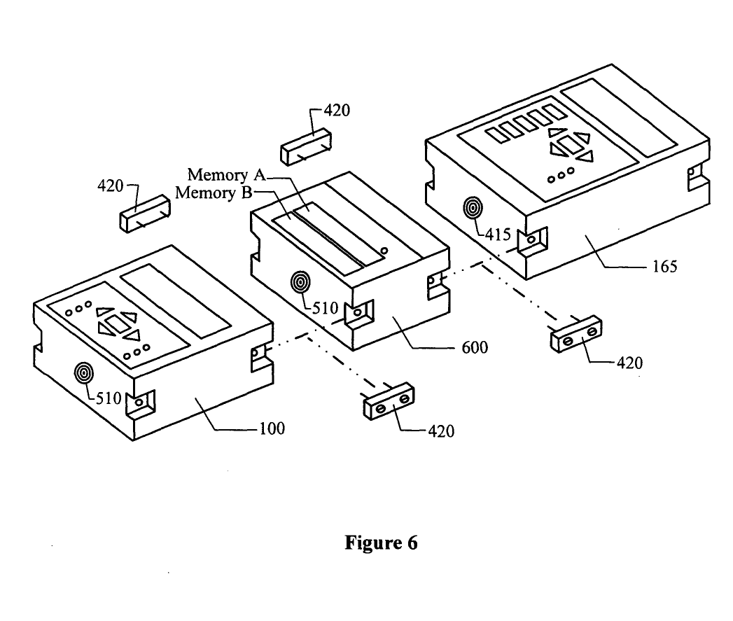

Referring to FIG. 6, the controller module 502, application module 165 and a memory module 600 are shown in a different configuration with respect to each other. Namely, the memory module 600 is now connected between the application module 165 and controller module 502 with its memories loaded from the top rather than parallel to the system axis as in FIG. 5. The memory module 600 in this embodiment has electrical connectors 415 on its opposite sides, along the system axis, for this purpose.

While various embodiments of the application have been described, it will be apparent to those of ordinary skill in the art that many more embodiments and implementations are possible that are within the scope of this invention.

1. A memory control system, comprising:
a processor;
a bus in communication with the processor;
a first memory in communication with the processor in a first data path removed from the bus; and
a second memory in communication with the processor in a second data path removed from the bus and having an empty memory indicator;
wherein, in response to the second memory containing no application data, the second memory provides a corresponding indication to the processor.

2. The system of claim 1, further comprising:
a hub in communication with the bus to provide application data to the processor.

3. A memory control system, comprising:
a controller module having a first data path, a second data path, and a bus; and
a first memory in communication with the first data path; and
a second memory in communication with the second data path and having an empty memory indicator;
wherein the controller module replicates data from the first memory to the second memory in response an empty data indication from the second memory.

4. The system of claim 3, further comprising:
an application module in communication with the controller module, wherein the controller module is connected to retrieve application data from the application module for storage in the first memory.

5. The system of claim 3, further comprising:
a memory module in communication with the controller module and containing the first memory and the second memory.

6. The system of claim 3, further comprising:
an application electrical connector on the application module; and
a controller electrical connector on the electrical applications controller in communication with the application electrical connector;
wherein each of said electrical connectors are axially symmetric to enable different relative rotational positions between the application and connector modules.

7. The system of claim 4, further comprising:
means for releasably connecting the application module to the electrical applications controller, said means enabling the application module and the electrical applications controller to be disengaged and break electrical communication between them, rotated 180 degrees and reengaged to reestablish electrical communication between them.

8. A method of installing a new memory that has a pretermined memory capacity into a system that comprises a processor and first old memory, with the first old memory storing an amount of application data to produce a redundant array of independent memories, comprising:
initiating a duplication function in the processor;
transmitting an empty data indication from the new memory to the processor; and
replicating the application data from the first old memory to the new memory.

9. The method of claim 8, wherein replicating the application data comprises comparing the amount of application data in the first old memory to the capacity of the new memory to determine whether said capacity is sufficient to hold the application data.

10. The method of claim 8, wherein replicating the application data comprises comparing the amount of application data in the first old memory to the capacity of the new memory to determine whether said capacity is sufficient to hold the application data.

11. A method of installing a new memory that has a predetermined capacity and a new memory ID into a system that comprises a processor and first and second old memory having respective first and second memory IDs, first and second old memories, said memories capable of storing application data, comprising:
removing the first of old memory from the system;
installing the new memory into the system;
determining whether the new memory ID matches either of the first or second memory IDs; and
replicating the application data from the second old memory to the new memory if the new memory ID does not match either of the first or second memory IDs, to maintain a redundant array of independent memories.

12. The method of claim 11, wherein said new memory transmits an empty data indication to said processor if said new memory does not store any data, and said transmission enables said data replication.
